(19) United States
(12) Patent Application Publication
(10) Pub. No.: US 2012/0127266 A1
(43) Pub. Date: May 24, 2012

(54) METHOD AND APPARATUS FOR PROVIDING STEREOSCOPIC 3D BROADCASTING SERVICE COMPATIBLE WITH HD BROADCASTING SERVICE

(75) Inventors: Eung Don LEE, Daejeon (KR); Se Yoon JEONG, Daejeon (KR); Sang Woo AHN, Daejeon (KR); Jin Soo CHOI, Daejeon (KR); Jin Woong KIM, Daejeon (KR)

(73) Assignee: Electronics and Telecommunications Research Institute, Daejon (KR)

(21) Appl. No.: 13/303,379

(22) Filed: Nov. 23, 2011

(30) Foreign Application Priority Data
Nov. 24, 2010 (KR) 10-2010-0117550
May 25, 2011 (KR) 10-2011-0049648

(51) Int. Cl. H04N 13/00

(52) U.S. Cl. 348/42; 348/E13.001

(57) ABSTRACT

A method and apparatus for providing a broadcasting service are provided. The broadcasting service may be classified based on a broadcasting service type, such as a frame-compatible service, and a service-compatible service. Additionally, a descriptor may be generated based on the broadcasting service type, and a compatibility between a stereoscopic three-dimensional (3D) broadcasting service and a single stream-based broadcasting service may be provided.

### CROSS-REFERENCE TO RELATED APPLICATIONS

This application claims the benefit of Korean Patent Application No. 10-2010-0117550 and of Korean Patent Application No. 10-2011-0049648, respectively filed on Nov. 24, 2010 and May 25, 2011, in the Korean Intellectual Property Office, the disclosures of which are incorporated herein by reference.

### BACKGROUND

1. Field of the Invention

The present invention relates to an apparatus and method for providing backward compatibility between a stereoscopic three-dimensional (3D) broadcasting service, and a High Definition (HD) broadcasting service that provides a two-dimensional (2D) video.

2. Description of the Related Art

In general, among stereoscopic three-dimensional (3D) broadcasting services, a frame-compatible service and a service-compatible service are compatible with a High Definition (HD) broadcasting service.

The frame-compatible service may be used to form a left video and a right video, and to provide the left video and the right video in the form of a single stream. Here, the left video and the right video may be formed in a checkerboard-based interleaving frame-compatible format, a column-based interleaving frame-compatible format, a row-based interleaving frame-compatible format, a side-by-side frame-compatible format, and a top-and-bottom frame-compatible format. Here, a conventional High Definition Television (HDTV) used to play back a two-dimensional (2D) video may display a 2D video by superimposing the left video and the right video, or by placing the left video and the right video one next to the other, or by placing the left video and the right video one above the other. Additionally, when the frame-compatible service is provided, a conventional 3DTV may display a stereoscopic 3D video by separating a left video and a right video.

The service-compatible service may be used to form and provide a dual stream with an HD video and a 3D video so that the HD video and the 3D video are independent of each other. Here, the conventional HDTV may display a 2D video corresponding to the HD video, and the conventional 3DTV may display a stereoscopic video corresponding to the 3D video. Additionally, the service-compatible service may include a 2D service-compatible service, a frame compatible-and-service compatible service.

First, in the 2D service-compatible service, a full HD reference video and an additional video may be formed and provided in a dual-stream format, so that the full HD reference video and the additional video may be independent of each other. Additionally, in the 2D service-compatible service, a full HD reference video and a frame-compatible 3D video may be formed and provided in the dual-stream format, so that the full HD reference video and the frame-compatible 3D video may be independent of each other. Here, when the full HD reference video and the additional video are provided in the dual-stream format, the HDTV may display the full HD reference video, and the 3DTV may display a full HD stereoscopic 3D video, by separating a left video and a right video. Additionally, when the full HD reference video and the frame-compatible 3D video are provided in the dual-stream format, the HDTV may display the full HD reference video, and the 3DTV may display a stereoscopic 3D video, by separating a left video and a right video.

Second, in the frame compatible-and-service compatible service, a frame-compatible 3D video and an enhancement layer video may be formed and provided in the dual-stream format, so that the frame-compatible 3D video and the enhancement layer video may be independent of each other. Here, the HDTV may display a 2D video in which the left video and the right video are superimposed, or a 2D video in which the left video and the right video are placed one next to the other, or placed one above the other. Additionally, the 3DTV may add the enhancement layer video to the left video and the right video that are separated, and may provide a full HD stereoscopic 3D video.

In the service-compatible service, a broadcasting stream includes two independent streams, namely, a dual stream. However, the conventional HDTV provides a single stream-based broadcasting service. For example, when the service-compatible service is provided, the conventional HDTV may malfunction due to signaling of a stereoscopic 3D broadcasting service.

Accordingly, there is a desire for a technology that may provide compatibility between an HD broadcasting service and a stereoscopic 3D broadcasting service.

### SUMMARY

An aspect of the present invention provides a signaling method for providing a compatibility between an existing High Definition (HD) broadcasting service and a stereoscopic three-dimensional (3D) broadcasting service, using a Program Map Table (PMT), and for classifying the stereoscopic 3D broadcasting service, such as a frame-compatible service, or a service-compatible service.

According to an aspect of the present invention, there is provided a method of providing a broadcasting service, the method including: classifying a broadcasting service based on a broadcasting service type; and providing a compatibility between a stereoscopic 3D broadcasting service and a single stream-based broadcasting service.

The classifying may include generating a stereoscopic program information descriptor indicating program information of a video corresponding to the broadcasting service type. The broadcasting service type may include at least one of a frame-compatible service, and a service-compatible service.

The providing may include setting a stream_type field, depending on whether a playback of a 3D video in a High-Definition Television (HDTV) is permitted based on the broadcasting service type. Additionally, the providing may include setting a stream_type field, and generating a stereoscopic video information descriptor based on the broadcasting service type.

The providing may include generating a Program Map Table (PMT) including at least one of the stereoscopic program information descriptor, the stereoscopic video information descriptor, and the stream_type field.

The classifying may include generating a PMT including at least one of the stereoscopic program information descriptor, the stereoscopic video information descriptor, and the stream_type field.

The classifying may include, when the broadcasting service type is a service-compatible service, setting the stream_type field to a reserved value of 1 or 2.

According to another aspect of the present invention, there is provided an apparatus for providing a broadcasting service, the apparatus including: a PMT generator to generate a PMT based on a broadcasting service type; and a stream transmitter to transmit the PMT, and a video corresponding to the broadcasting service type.

### EFFECT

According to embodiments of the present invention, it is possible to provide a compatibility between an existing High Definition (HD) broadcasting service and a stereoscopic three-dimensional (3D) broadcasting service, using a Program Map Table (PMT), and to classify the stereoscopic 3D broadcasting service, such as a frame-compatible service, or a service-compatible service.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a flowchart illustrating a method of providing a broadcasting service in a broadcasting service providing apparatus according to an embodiment of the present invention;

FIG. 2 is a flowchart illustrating an operation of generating descriptors in a broadcasting service providing apparatus according to an embodiment of the present invention; and

FIG. 3 is a block diagram illustrating a broadcasting service providing apparatus according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

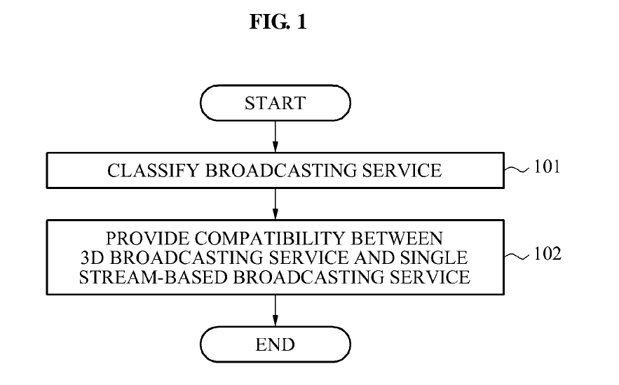

FIG. 1 is a flowchart illustrating a method of providing a broadcasting service in a broadcasting service providing apparatus according to an embodiment of the present invention.

Referring to FIG. 1, in operation 101, the broadcasting service providing apparatus may classify a broadcasting service based on a broadcasting service type. The broadcasting service type may include a frame-compatible service, and a service-compatible service. Additionally, the service-compatible service may include a two-dimensional (2D) service-compatible service, and a frame compatible-and-service compatible service. The 2D service-compatible service may include a 2D-and-2D service and a 2D-and-frame compatible service.

Here, the broadcasting service providing apparatus may generate a stereoscopic program information descriptor indicating program information of a video corresponding to the broadcasting service type.

In operation 102, the broadcasting service providing apparatus may provide a compatibility between a three-dimensional (3D) broadcasting service and a single stream-based broadcasting service. The single stream-based broadcasting service may refer to a High Definition (HD) broadcasting service that provides a 2D video. The 3D broadcasting service may include, for example, a stereoscopic 3D broadcasting service.

Here, the broadcasting service providing apparatus may set a stream_type field to a reserved value, or to a stream type value that is already defined, based on the broadcasting service type. Additionally, the broadcasting service providing apparatus may generate a stereoscopic video information descriptor, based on the stereoscopic program information descriptor.

Values reserved for the stream_type field are shown as Table 1.

TABLE 1

| Reserved value | Description |
|---|---|
| Reserved 1 | Frame compatible stereoscopic video coded using |
| (e.g., 0x22) | frame packing arrangement |
| Reserved 2 | Service-compatible 3D stereoscopic video |
| (e.g., 0x23) | |

The stream_type field may be used to permit or prevent a playback of a 3D video in a High Definition Television (HDTV).

In an example, when the broadcasting service type is the frame-compatible service, the broadcasting service providing apparatus may set the stream_type field to “0x02,” namely, a stream type value used in an existing HD broadcasting service, to permit the playback of the 3D video in the HDTV. In this example, to prevent the playback of the 3D video in the HDTV, the broadcasting service providing apparatus may set the stream_type field to “0x22,” namely, a stream type value that is not used in the existing HD broadcasting service.

In another example, when the broadcasting service type is the 2D-and-2D service and the 2D-and-frame compatible service in the service-compatible service, the broadcasting service providing apparatus may set the stream_type field to “0x02” as a stream type value of a reference video, may set the stream_type field to “0x23” and “0x22” as stream type values of additional videos, and may permit a playback of only the reference video of the 3D video in the HDTV. In still another example, when the broadcasting service type is the frame compatible-and-service compatible service in the service-compatible service, the broadcasting service providing apparatus may set the stream_type field to “0x02” as a stream type value of the reference video (for example, a frame-compatible 3D video), and may set the stream_type field “0x23” as a stream type value of an additional video (for example, an enhancement layer video corresponding to the frame-compatible 3D video), to permit the playback of the 3D video in the HDTV. In this example, to prevent the playback of the 3D video in the HDTV, the broadcasting service providing apparatus may set the stream_type field “0x22” as a stream type value of the reference video, and may set the stream_type field “0x23” as a stream type value of an additional video.

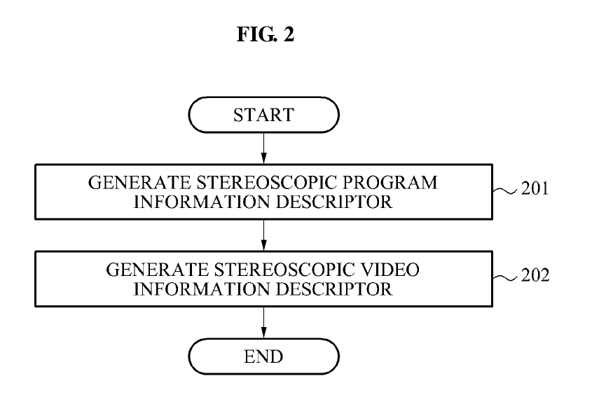

Generating of the stereoscopic program information descriptor, and the stereoscopic video information descriptor will be further described later with reference to FIG. 2.

Additionally, the broadcasting service providing apparatus may generate a Program Map Table (PMT) including at least one of the stereoscopic program information descriptor, the stereoscopic video information descriptor, and the stream_type field. Subsequently, the broadcasting service providing apparatus may transmit, to a broadcast receiving apparatus, the PMT, and a stereoscopic 3D video corresponding to the broadcasting service type. The broadcast receiving apparatus may include, for example, a Set-Top Box (STB), a 3DTV, an HDTV, and the like.

FIG. 2 is a flowchart illustrating an operation of generating descriptors in a broadcasting service providing apparatus according to an embodiment of the present invention.

Referring to FIG. 2, in operation 201, the broadcasting service providing apparatus may generate a stereoscopic program information descriptor indicating program information of a video corresponding to a broadcasting service type.

The stereoscopic program information descriptor may include a descriptor_tag field, a stereoscopic_program_flag field, a stereoscopic_service_type field, an additional_channel_present_flag field, an additional_stream_channel_TSID field, and an additional_stream_PMT_PID field.

First, to prevent malfunction due to addition of a new descriptor in an existing HDTV, the broadcasting service providing apparatus may set the descriptor_tag field to one of reserved values. For example, to generate a stereoscopic program information descriptor, the broadcasting service providing apparatus may set the descriptor_tag field to a reserved 3, for example 52, as shown in Table 2.

TABLE 2

| descriptor_tag | TS | PS | Definition |
|---|---|---|---|
| Reserved 3 | X | X | Stereoscopic_program_information_descriptor |
| (e.g., 52) | | | |
| Reserved 4 | X | X | Stereoscopic_video_information_descriptor |
| (e.g., 53) | | | |

Referring to Table 2, the stereoscopic program information descriptor, and the stereoscopic video information descriptor may be distinguished from each other based on a descriptor_tag field of each of the stereoscopic program information descriptor and the stereoscopic video information descriptor.

Subsequently, the broadcasting service providing apparatus may set the stereoscopic_program_flag field, based on a program type.

In an example, when the program type is a 3D broadcast program, the broadcasting service providing apparatus may set the stereoscopic_program_flag field to “1.” In another example, when the program type is a 2D broadcast program, the broadcasting service providing apparatus may set the stereoscopic_program_flag field to “0.” In other words, when the 3D broadcasting service is provided, the broadcasting service providing apparatus may provide both the 3D broadcast program and the 2D broadcast program together, over all broadcasting time zones. Additionally, the broadcasting service providing apparatus may classify a program type of the 3D broadcasting service, based on the stereoscopic_program_flag field. Accordingly, the broadcasting service providing apparatus may classify the program type, and may provide a broadcasting service to a broadcast receiving apparatus.

In addition, the broadcasting service providing apparatus may set the stereoscopic_service_type field, based on the broadcasting service type. The broadcasting service type may include a frame-compatible service, and a service-compatible service. The service-compatible service may include a 2D-and-2D service, a 2D-and-frame compatible service, and a frame compatible-and-service compatible service.

TABLE 3

| Value | Description |
|---|---|
| 0000 | Frame-compatible service |
| 0001 | 2D-and-2D service in service-compatible service |
| | (2D + 2D dual stream) |
| 0010 | 2D-and-frame compatible service in service-compatible |
| | service (2D + frame-compatible dual stream) |
| 0011 | Frame compatible-and-service compatible service in service- |
| | compatible service |
| | (frame-compatible + enhancement layer dual stream) |
| 0110-1111 | Reserved |

Referring to Table 3, in an example, when the broadcasting service type is the frame-compatible service, the broadcasting service providing apparatus may set the stereoscopic_service_type field to “0000.” In another example, when the broadcasting service type is the 2D-and-2D service, the broadcasting service providing apparatus may set the stereoscopic_service_type field to “0001.” In still another example, when the broadcasting service type is the 2D-and-frame compatible service, the broadcasting service providing apparatus may set the stereoscopic_service_type field to “0010.” In yet another example, when the broadcasting service type is the frame compatible-and-service compatible service, the broadcasting service providing apparatus may set the stereoscopic_service_type field to “0011.”

Subsequently, the broadcasting service providing apparatus may set the additional_channel_present_flag field, depending on whether an additional channel is used.

For example, when the broadcasting service providing apparatus provides a 3D broadcasting service using an additional channel that is physically separated, the broadcasting service providing apparatus may set the additional_channel_present_flag field to “1.” In this example, when the additional channel is not used, the broadcasting service providing apparatus may set the additional_channel_present_flag field to “0.”

Additionally, the broadcasting service providing apparatus may set the additional_stream_channel_TSID field, based on the broadcasting service type.

In an example, when the broadcasting service type is the 2D-and-2D service, the broadcasting service providing apparatus may set the additional_stream_channel_TSID field to a Transmission Signal Identifier (TSID) of a channel including an additional video corresponding to a reference video. In another example, when the broadcasting service type is the 2D-and-frame compatible service, the broadcasting service providing apparatus may set the additional_stream_channel_TSID field to a TSID of a channel including a frame-compatible 3D video. Similarly, when the broadcasting service type is the frame compatible-and-service compatible service, the broadcasting service providing apparatus may set the additional_stream_channel_TSID field to a TSID of a channel including an enhancement layer video corresponding to a frame-compatible 3D video.

Subsequently, the broadcasting service providing apparatus may set the additional_stream_PMT_PID field, based on the broadcasting service type.

In an example, when the broadcasting service type is the 2D-and-2D service, the broadcasting service providing apparatus may set the additional_stream_PMT_PID field to a PMT PID (Packet ID) of a channel including an additional video corresponding to a reference video. In another example, when the broadcasting service type is the 2D-and-frame compatible service, the broadcasting service providing apparatus may set the additional_stream_PMT_PID field to a PMT PID of a channel including a frame-compatible 3D video. Similarly, when the broadcasting service type is the frame compatible-and-service compatible service, the broadcasting service providing apparatus may set the additional_stream_PMT_PID field to a PMT PID of a channel including an enhancement layer video corresponding to a frame-compatible 3D video.

As described above, the broadcasting service providing apparatus may set each of the fields of the stereoscopic program information descriptor based on the broadcasting service type, and may generate the stereoscopic program information descriptor. The stereoscopic program information descriptor may describe a program level, and may be used as a descriptor in a first loop of a PMT. For example, the stereoscopic program information descriptor may be defined as shown in Table 4.

TABLE 4

| | | |
|---|---|---|
| | Number | |
| Syntax | of bits | Format |

stereoscopic_program_information_descriptor( ) {

| | | |
|---|---|---|
| descriptor_tag | 8 | uimsbf |
| descriptor_length | 8 | uimsbf |
| reserved | 7 | bslbf |
| stereoscopic_program_flag | 1 | bslbf |
| if (stereoscopic_program_flag==‘1’) { | | |

| | | |
|---|---|---|
| reserved | 4 | bslbf |
| stereoscopic_service_type | 4 | uimsbf |

| | | |
|---|---|---|
| } | | |
| reserved | 7 | bslbf |
| additional_channel_present_flag | 1 | bslbf |
| if (additional_channel_present_flag==‘1’) { | | |

| | | |
|---|---|---|
| reserved | 3 | bslbf |
| additional_stream_channel_TSID | 13 | uimsbf |
| reserved | 3 | bslbf |
| additional_stream_PMT_PID | 13 | uimsbf |

}

}

In Table 4, “bslbf” stands for Bit String Left Bit First, “rpchof” stands for Remainder Polynomial Coefficients Highest Order First, and “tcimsbf” stands for Two's Complement Integer MSB (Sigh) Bit First. Additionally, “uimsbf” stands for Unsigned Integer, Most Significant Bit First, and “vlclbf” stands for Variable Length Code Left Bit First.

In operation 202, the broadcasting service providing apparatus may generate a stereoscopic video information descriptor, based on generating of the stereoscopic program information descriptor.

The stereoscopic video information descriptor may include a descriptor_tag field, a codec_type field, a stereoscopic_composition_type field, a stereoscopic_view_relationship_flag field, and a reference_elementary_stream_PID field.

First, to prevent malfunction due to addition of a new descriptor in an existing HDTV, the broadcasting service providing apparatus may set the descriptor_tag field of the stereoscopic video information descriptor to one of reserved values. For example, the broadcasting service providing apparatus may set the descriptor_tag field to a reserved 4, for example 53, as shown in Table 2.

Subsequently, when the stereoscopic program information descriptor is generated, the broadcasting service providing apparatus may set the codec_type field, based on a type of a codec configured to compress a video corresponding to the broadcasting service type. For example, the broadcasting service providing apparatus may set the codec_type field to a value of a stream_type field that is defined in the International Organization for Standardization/International Electrotechnical Commission (ISO/IEC) 13818-1 Moving Picture Experts Group 2 (MPEG-2) system standard.

Additionally, the broadcasting service providing apparatus may set the stereoscopic_composition_type field, based on a composition type of a stereoscopic 3D video.

TABLE 5

| Value | Description |
|---|---|
| 0000 | 2D whole frame |
| 0001 | Checkerboard-based interleaving frame-compatible |
| 0010 | Column-based interleaving frame-compatible |
| 0011 | Row-based interleaving frame-compatible |
| 0100 | Side-by-side frame-compatible |
| 0101 | Top-and-bottom frame-compatible |
| 0110-1111 | Reserved |

Referring to FIG. 5, in an example, when the composition type of the stereoscopic 3D video corresponds to a 2D whole frame format, the broadcasting service providing apparatus may set the stereoscopic_composition_type field to “0000.” In another example, when the composition type of the stereoscopic 3D video corresponds to a checkerboard-based interleaving frame-compatible format, the broadcasting service providing apparatus may set the stereoscopic_composition_type field to “0001.” In still another example, when the composition type of the stereoscopic 3D video corresponds to a column-based interleaving frame-compatible format, the broadcasting service providing apparatus may set the stereoscopic_composition_type field to “0010.” In still another example, when the composition type of the stereoscopic 3D video corresponds to a row-based interleaving frame-compatible format, the broadcasting service providing apparatus may set the stereoscopic_composition_type field to “0011.” In a further example, when the composition type of the stereoscopic 3D video corresponds to a side-by-side frame-compatible format, the broadcasting service providing apparatus may set the stereoscopic_composition_type field to “0100.” In a further example, when the composition type of the stereoscopic 3D video corresponds to a top-and-bottom frame-compatible format, the broadcasting service providing apparatus may set the stereoscopic_composition_type field to “0101.”

Subsequently, the broadcasting service providing apparatus may set the stereoscopic_view_relationship_flag field, based on the broadcasting service type. Here, the stereoscopic_view_relationship_flag field may be used to distinguish a left video from a right video.

In an example in which the broadcasting service type is a frame-compatible service, or a 2D-and-frame compatible service, or a frame compatible-and-service compatible service, when a frame corresponding to an upper left side is a left video, the broadcasting service providing apparatus may set the stereoscopic_view_relationship_flag field to “1.” In this example, when the frame is a right video, the broadcasting service providing apparatus may set the stereoscopic_view_relationship_flag field to In other words, the stereoscopic_view_relationship_flag field may be used to determine whether the frame is a left video or a right video.

In another example in which the broadcasting service type is a 2D-and-2D service, when an additional video is a left video, the broadcasting service providing apparatus may set the stereoscopic_view_relationship_flag field to “0.” In this example, when the additional video is a right video, the broadcasting service providing apparatus may set the stereoscopic_view_relationship_flag field to “1.” In other words, when the stereoscopic_view_relationship_flag field is set to “0,” the additional video may be the left video, and a reference video may be the right video. When the stereoscopic_view_relationship_flag field is set to “1,” the additional video may be the right video, and a reference video may be the left video.

Additionally, the broadcasting service providing apparatus may set the reference_elementary_stream_PID field, based on a PID of a reference video corresponding to an additional video.

As described above, when the stereoscopic program information descriptor is generated, the broadcasting service providing apparatus may set each of fields of a stereoscopic video information descriptor, based on the broadcasting service type, and may generate the stereoscopic video information descriptor. The stereoscopic video information descriptor may describe an Elementary Stream (ES) level, and may be used as a descriptor in a second loop of a PMT. For example, the stereoscopic video information descriptor may be defined as shown in Table 6.

TABLE 6

| | | |
|---|---|---|
| | Number | |
| Syntax | of bits | Format |

stereoscopic_video_information_descriptor( ) {

| | | |
|---|---|---|
| descriptor_tag | 8 | uimsbf |
| descriptor_length | 8 | uimsbf |
| codec_type | 8 | uimsbf |
| reserved | 3 | bslbf |
| stereoscopic_composition_type | 4 | uimsbf |
| stereoscopic_view_relationship_flag | 1 | bslbf |
| reserved | 3 | bslbf |
| reference_elementary_stream_PID | 13 | uimsbf |

}

The broadcasting service providing apparatus may also generate a PMT of Program Specific Information (PSI), using the stereoscopic video information descriptor, the stereoscopic program information descriptor, and the stream_type field. Additionally, the broadcasting service providing apparatus may transmit the generated PMT to at least one broadcast receiving apparatus.

In response to the PMT, the broadcast receiving apparatus may play back at least one of a 2D broadcasting service and a 3D broadcasting service, based on the received PMT. For example, Table 7 shows playback modes to play back a video on a broadcast receiving apparatus, such as an HDTV, a 3DTV, and the like, when the broadcasting service providing apparatus provides both the 2D broadcasting service and the 3D broadcasting service.

TABLE 7

| | | | | HDTV playback mode | | 3DTV playback mode | |
|---|---|---|---|---|---|---|---|
| | | | | Frame- | Frame- | Frame- | Frame- |
| | | | | compatible | compatible | compatible | compatible |
| | | | | service is | service is | service is | service is |
| 3DTV service | | Program | | not supported | supported | not supported | supported |
| Frame- | | 2D | | Full HD | Full HD | Full HD | Full HD |
| compatible | | | | 2D video | 2D video | 2D video | 2D video |
| service | | | | is played | is played | is played | is played |
| | | | | back | back | back | back |
| | | 3D | Permitted | 2D video | 2D video | Stereoscopic | Stereoscopic |
| | | | to be | is played | is played | video is | video is |
| | | | played | back by | back | played | played |
| | | | back on | superimposing | | back | back |
| | | | HDTV | left video | | | |
| | | | | and right | | | |
| | | | | video, or | | | |
| | | | | by placing | | | |
| | | | | left video | | | |
| | | | | and right | | | |
| | | | | video one | | | |
| | | | | next to the | | | |
| | | | | other, or | | | |
| | | | | one above | | | |
| | | | | the other | | | |
| | | | Prevented | Playback | 2D video | Stereoscopic | Stereoscopic |
| | | | from | is | is played | video is | video is |
| | | | being | impossible | back | played | played |
| | | | played | | | back | back |
| | | | back on | | | | |
| | | | HDTV | | | | |
| Service- | 2D-and- | 2D | | Full HD | Full HD | Full HD | Full HD |
| compatible | 2D service | | | 2D video | 2D video | 2D video | 2D video |
| service | | | | is played | is played | is played | is played |
| | | | | back | back | back | back |
| | | 3D | | Full HD | Full HD | Full HD | Full HD |
| | | | | reference | reference | reference | stereoscopic |
| | | | | video is | video is | video is | video is |
| | | | | played | played | played | played |
| | | | | back | back | back | back |
| | 2D-and- | 2D | | Full HD | Full HD | Full HD | Full HD |
| | frame | | | 2D video | 2D video | 2D video | 2D video |
| | compatible | | | is played | is played | is played | is played |
| | service | | | back | back | back | back |
| | | 3D | | Full HD | Full HD | Full HD | Stereoscopic |
| | | | | 2D video | 2D video | 2D video | video is |
| | | | | is played | is played | is played | played |
| | | | | back | back | back | back |
| | Frame | 2D | | Full HD | Full HD | Full HD | Full HD |
| | compatible- | | | 2D video | 2D video | 2D video | 2D video |
| | and- | | | is played | is played | is played | is played |
| | service | | | back | back | back | back |
| | compatible | 3D | Permitted | 2D video | 2D video | Stereoscopic | Full HD |
| | service | | to be | is played | is played | video is | stereoscopic |
| | | | played | back by | back | played | video is |
| | | | back on | superimposing | | back | played |
| | | | HDTV | left video | | | back |
| | | | | and right | | | |
| | | | | video, or | | | |
| | | | | by placing | | | |
| | | | | left video | | | |
| | | | | and right | | | |
| | | | | video one | | | |
| | | | | next to the | | | |
| | | | | other, or | | | |
| | | | | one above | | | |
| | | | | the other | | | |
| | | | Prevented | Playback | 2D video | Stereoscopic | Full HD |
| | | | from | is | is played | video is | stereoscopic |
| | | | being | impossible | back | played | video is |
| | | | played | | | back | played |
| | | | back on | | | | back |
| | | | HDTV | | | | |

Table 8 shows an example of the above-described PMT that includes the stereoscopic program information descriptor, the stereoscopic video information descriptor, and the stream_type field.

TABLE 8

| | | | | Stereoscopic program | Stream_type | Stereoscopic video |
|---|---|---|---|---|---|---|
| 3DTV service | | Program | | information descriptor | field | information descriptor |
| Frame- | | 2D | | stereoscopic_program_flag: ‘0’ | Reference | — |
| compatible | | | | additional_channel_present_flag: | video stream: | |
| service | | | | ‘0’ | 0x02 | |
| | | 3D | Permitted | stereoscopic_program_flag: ‘1’ | FC stream: | codec_type: 0x02 |
| | | | to be | stereoscopic_service_type: ‘0000’ | 0x02 | stereoscopic_composition_type: |
| | | | played | additional_channel_present_flag: | | ‘0001’-‘0101’ |
| | | | back on | ‘0’ | | stereoscopic_view_relationship_flag: ‘X’ |
| | | | HDTV | | | reference_elementary_stream_PID: |
| | | | | | | ‘FC stream PID’ |
| | | | Prevented | stereoscopic_program_flag: ‘1’ | FC stream: | codec_type: 0x02 |
| | | | from being | stereoscopic_service_type: ‘0000’ | 0x22 | stereoscopic_composition_type: |
| | | | played | additional_channel_present_flag: | | ‘0001’-‘0101” |
| | | | back on | ‘0’ | | stereoscopic_view_relationship_flag: ‘X’ |
| | | | HDTV | | | reference_elementary_stream_PID: |
| | | | | | | ‘FC stream PID’ |
| Service- | 2D-and- | 2D | | stereoscopic_program_flag: ‘0’ | Reference | — |
| compatible | 2D | | | additional_channel_present_flag: | video stream: | |
| service | service | | | ‘0’ | 0x02 | |
| | | | | | Additional | |
| | | | | | video stream: — | |
| | | 3D | | stereoscopic_program_flag: ‘0’ | Reference | — |
| | | | | stereoscopic_service_type: ‘0001’ | video stream: | codec_type: 0x1B |
| | | | | additional_channel_present_flag: | 0x02 | stereoscopic_composition_type: ‘0000’ |
| | | | | ‘X’ | Additional | stereoscopic_view_relationship_flag: ‘X’ |
| | | | | | video stream: | reference_elementary_stream_PID: |
| | | | | | 0x23 | ‘reference video PID’ |
| | 2D-and- | 2D | | stereoscopic_program_flag: ‘0’ | Reference | — |
| | frame | | | additional_channel_present_flag: | video stream: | |
| | compatible | | | ‘0’ | 0x02 | |
| | service | | | | FC stream: — | |
| | | 3D | | stereoscopic_program_flag: ‘0’ | Reference | — |
| | | | | stereoscopic_service_type: ‘0010’ | video stream: | codec_type: 0x1B |
| | | | | additional_channel_present_flag: | 0x02 | stereoscopic_composition_type: |
| | | | | ‘X’ | FC stream: | ‘0001’-‘0101” |
| | | | | | 0x22 | stereoscopic_view_relationship_flag: ‘X’ |
| | | | | | | reference_elementary_stream_PID: |
| | | | | | | ‘reference video PID’ |
| | Frame | 2D | | stereoscopic_program_flag: ‘0’ | Reference | — |
| | compatible- | | | additional_channel_present_flag: | video stream: | |
| | and- | | | ‘0’ | 0x02 | |
| | service | | | | enhancement | |
| | compatible | | | | layer stream: — | |
| | service | 3D | Permitted to | stereoscopic_program_flag: ‘0’ | FC stream: | codec_type: 0x02 |
| | | | be played | stereoscopic_service_type: ‘0011’ | 0x02 | stereoscopic_composition_type: |
| | | | back on | additional_channel_present_flag: | enhancement | ‘0001’-‘0101” |
| | | | HDTV | ‘X’ | layer stream: | stereoscopic_view_relationship_flag: ‘X’ |
| | | | | | 0x23 | reference_elementary_stream_PID: |
| | | | | | | ‘FC stream PID’ |
| | | | | | | codec_type: 0x1B |
| | | | | | | stereoscopic_composition_type: |
| | | | | | | ‘0001’-‘0101” |
| | | | | | | stereoscopic_view_relationship_flag: ‘X’ |
| | | | | | | reference_elementary_stream_PID: |
| | | | | | | ‘FC stream PID’ |
| | | | Prevented | stereoscopic_program_flag: ‘0’ | FC stream: | codec_type: 0x02 |
| | | | from being | stereoscopic_service_type: ‘0011’ | 0x22 | stereoscopic_composition_type: |
| | | | played | additional_channel_present_flag: | enhancement | ‘0001’-‘0101” |
| | | | back on | ‘X’ | layer stream: | stereoscopic_view_relationship_flag: ‘X’ |
| | | | HDTV | | 0x23 | reference_elementary_stream_PID: |
| | | | | | | ‘FC stream PID’ |
| | | | | | | codec_type: 0x1B |
| | | | | | | stereoscopic_composition_type: |
| | | | | | | ‘0001’-‘0101” |
| | | | | | | stereoscopic_view_relationship_flag: ‘X’ |
| | | | | | | reference_elementary_stream_PID: |
| | | | | | | ‘FC stream PID’ |

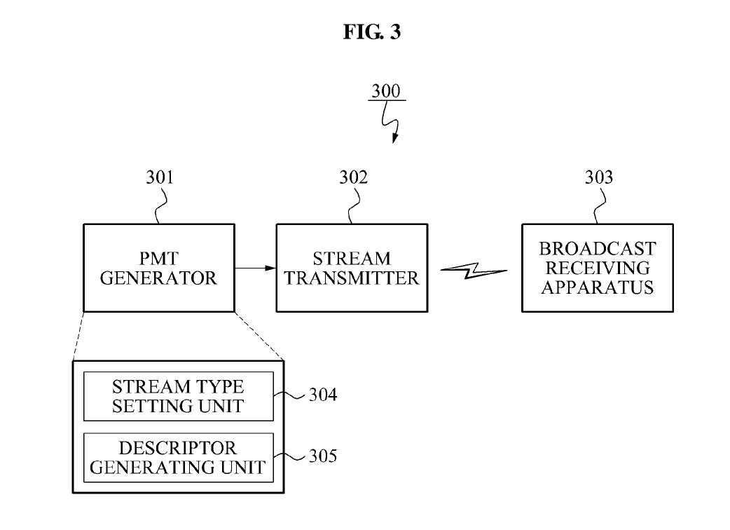

FIG. 3 is a block diagram illustrating a configuration of a broadcasting service providing apparatus 300 according to an embodiment of the present invention.

Referring to FIG. 3, the broadcasting service providing apparatus 300 may include a PMT generator 301, and a stream transmitter 302.

The PMT generator 301 may generate a PMT based on a broadcasting service type. The PMT generator 301 may include a stream type setting unit 304, and a descriptor generating unit 305.

The stream type setting unit 304 may set a stream_type field, depending on whether a playback of a 3D video in an HDTV is permitted based on the broadcasting service type. The broadcasting service type may include a frame-compatible service, and a service-compatible service. Additionally, the service-compatible service may include a 2D service-compatible service, and a frame compatible-and-service compatible service. The 2D service-compatible service may include a 2D-and-2D service, and a 2D-and-frame compatible service.

In an example, when the broadcasting service type is the frame-compatible service, the stream type setting unit 304 may set the stream_type field to “1” among reserved values. Referring to Table 1, the stream type setting unit 304 may set the stream_type field to “0x22.” Accordingly, the stream type setting unit 304 may prevent the playback of the 3D video in the HDTV, by setting the stream_type field to a reserved value of “1.”

In another example, when the broadcasting service type is the frame-compatible service, the stream type setting unit 304 may set the stream_type field to a stream type value that is already defined. For example, the stream type setting unit 304 may set the stream_type field to “0x02.” Accordingly, the stream type setting unit 304 may permit the playback of the 3D video in the HDTV, by setting the stream_type field to “0x02.”

In still another example, when the broadcasting service type is the service-compatible service, the stream type setting unit 304 may set the stream_type field to a reserved value of “1” or “2.” Specifically, when the broadcasting service type is the 2D-and-2D service in the service-compatible service, the stream type setting unit 304 may set a stream_type field for an additional video to “2” among the reserved values. For example, the stream type setting unit 304 may set a stream_type field for a reference video to “0x22,” and may set a stream_type field for an additional video to “0x23,” as shown in Table 1. In other words, when the stream_type field is set to the reserved value of “2,” the HDTV may interpret only the stream_type field for the reference video, instead of interpreting the stream_type field for the additional video and thus, it is possible to prevent malfunction due to a 3D broadcasting service of a dual stream.

The descriptor generating unit 305 may generate, based on the broadcasting service type, a stereoscopic program information descriptor, and a stereoscopic video information descriptor. The stereoscopic program information descriptor may indicate program information of a video.

The stereoscopic program information descriptor may include a descriptor_tag field, a stereoscopic_program_flag field, a stereoscopic_service_type field, an additional_channel_present_flag field, an additional_stream_channel_TSID field, and an additional_stream_PMT_PID field.

The stereoscopic video information descriptor may include a descriptor_tag field, a codec_type field, a stereoscopic_composition_type field, a stereoscopic_view_relationship_flag field, and a reference_elementary_stream_PID field. The generating of the stereoscopic program information descriptor and the stereoscopic video information descriptor has already been described with reference to FIG. 2 and accordingly, further description thereof is omitted.

Additionally, the descriptor generating unit 305 may generate a PMT including at least one of the stereoscopic program information descriptor, the stereoscopic video information descriptor, and the stream_type field. The stereoscopic program information descriptor may describe a program level, and may be used as a descriptor in a first loop of the PMT. The stereoscopic video information descriptor may describe an ES level, and may be used as a descriptor in a second loop of the PMT.

The stream transmitter 302 may transmit, to a broadcast receiving apparatus 303, the PMT, and a video corresponding to the broadcasting service type.

In an example, when the broadcasting service type is a frame-compatible service, the stream transmitter 302 may transmit a frame-compatible 3D video to the broadcast receiving apparatus 303.

In another example, when the broadcasting service type is a 2D-and-2D service, the stream transmitter 302 may form a dual stream with a full HD reference video and an additional video, and may transmit the dual stream to the broadcast receiving apparatus 303.

In still another example, when the broadcasting service type is a 2D-and-frame compatible service, the stream transmitter 302 may form a dual stream with a full HD reference video and a frame-compatible 3D video, and may transmit the dual stream to the broadcast receiving apparatus 303.

In yet another example, when the broadcasting service type is a frame compatible-and-service compatible service, the stream transmitter 302 may form a dual stream with a frame-compatible 3D video and an enhancement layer video, and may transmit the dual stream to the broadcast receiving apparatus 303.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of providing a broadcasting service, the method comprising:
classifying a broadcasting service based on a broadcasting service type; and
providing a compatibility between a stereoscopic three-dimensional (3D) broadcasting service and a single stream-based broadcasting service.

2. The method of claim 1, wherein the classifying comprises generating a stereoscopic program information descriptor indicating program information of a video corresponding to the broadcasting service type, and
wherein the broadcasting service type comprises at least one of a frame-compatible service, and a service-compatible service.

3. The method of claim 1, wherein the providing comprises:
setting a stream_type field, depending on whether a playback of a 3D video in a High-Definition Television (HDTV) is permitted based on the broadcasting service type; and
generating a stereoscopic video information descriptor based on the broadcasting service type.

4. The method of claim 3, wherein the classifying comprises, when the broadcasting service type is a frame-compatible service, setting the stream_type field to a reserved value of 1.

5. The method of claim 3, wherein the classifying comprises, when the broadcasting service type is a frame-compatible service, setting the stream_type field to a stream type value that is already defined.

6. The method of claim 3, wherein the classifying comprises, when the broadcasting service type is a service-compatible service, setting the stream_type field to a reserved value of 1 or 2.

7. The method of claim 3, wherein the providing comprise generating a Program Map Table (PMT) comprising at least one of the stereoscopic program information descriptor, the stereoscopic video information descriptor, and the stream_type field.

8. The method of claim 3, wherein the stereoscopic video information descriptor comprises a descriptor_tag field, a codec_type field, a stereoscopic_composition_type field, a stereoscopic_view_relationship_flag field, and a reference_elementary_stream_PID field.

9. The method of claim 2, wherein the stereoscopic program information descriptor comprises a descriptor_tag field, a stereoscopic_program_flag field, a stereoscopic_service_type field, an additional_channel_present_flag field, an additional_stream_channel_TSID field, and an additional_stream_PMT_PID field.

10. The method of claim 2, wherein the classifying comprises generating a PMT comprising at least one of the stereoscopic program information descriptor, the stereoscopic video information descriptor, and the stream_type field.

11. An apparatus for providing a broadcasting service, the apparatus comprising:
a Program Map Table (PMT) generator to generate a PMT based on a broadcasting service type; and
a stream transmitter to transmit the PMT, and a video corresponding to the broadcasting service type.

12. The apparatus of claim 11, wherein the PMT generator comprises:
a stream type setting unit to set a stream_type field, based on the broadcasting service type; and
a descriptor generating unit to generate a stereoscopic program information descriptor indicating program information of the video, and to generate a stereoscopic video information descriptor based on the broadcasting service type.

13. The apparatus of claim 12, wherein, when the broadcasting service type is a frame-compatible service, the stream type setting unit sets the stream_type field to a reserved value of 1.

14. The apparatus of claim 12, wherein, when the broadcasting service type is a frame-compatible service, the stream type setting unit sets the stream_type field to a stream type value that is already defined.

15. The apparatus of claim 12, wherein, when the broadcasting service type is a service-compatible service, the stream type setting unit sets the stream_type field to a reserved value of 1 or 2.

16. The apparatus of claim 12, wherein the stereoscopic program information descriptor comprises a descriptor_tag field, a stereoscopic_program_flag field, a stereoscopic_service_type field, an additional_channel_present_flag field, an additional_stream_channel_TSID field, and an additional_stream_PMT_PID field.

17. The apparatus of claim 12, wherein the stereoscopic video information descriptor comprises a descriptor_tag field, a codec_type field, a stereoscopic_composition_type field, a stereoscopic_view_relationship_flag field, and a reference_elementary_stream_PID field.
